(19) United States
(12) Patent Application Publication
(10) Pub. No.: US 2010/0150470 A1
(43) Pub. Date: Jun. 17, 2010

(54) SYSTEMS AND METHODS FOR DEBLOCKING SEQUENTIAL IMAGES BY DETERMINING PIXEL INTENSITIES BASED ON LOCAL STATISTICAL MEASURES

(75) Inventors: Gerald M. Sherwood, Okotoks (CA); Gregory K. Lancaster, Calgary (CA); Leonard T. Bruton, Calgary (CA); Danny D. Lowe, Calgary (CA)

Correspondence Address: FULBRIGHT & JAWORSKI L.L.P, 2200 ROSS AVENUE, SUITE 2800, DALLAS, TX, 75201-2784, US

(73) Assignee: Headplay (Barbados) Inc.

(21) Appl. No.: 12/333,708

(22) Filed: Dec. 12, 2008

(51) Int. Cl. G06K 9/40

(52) U.S. Cl. 382/268

(57) ABSTRACT

Systems and methods are presented for improving the quality of an image as perceived by the Human Vision System by smoothing block artifacts in an image. In one embodiment, smoothing is accomplished by identifying target pixels to be smoothed and then replacing the pixel values of the target pixels with values derived from statistically similar neighboring pixels. The statistically similar neighboring pixels are chosen based on specific measurement criteria from within a region identified to contain such neighbors.

### CROSS-REFERENCE TO RELATED APPLICATIONS

This application is related to co-pending, commonly owned patent applications SYSTEMS AND METHODS FOR IMPROVING THE QUALITY OF COMPRESSED VIDEO SIGNALS BY SMOOTHING BLOCK ARTIFACTS, U.S. patent application Ser. No. 12/176,371, filed Jul. 19, 2008, Attorney Docket No. 54729/P010/10806075; SYSTEMS AND METHODS FOR IMPROVING THE QUALITY OF COMPRESSED VIDEO SIGNALS BY SMOOTHING THE ENTIRE FRAME AND OVERLAYING PRESERVED DETAIL, U.S. patent application Ser. No. 12/176,372, filed Jul. 19, 2008, Attorney Docket No. 54729/P011US/10808778; and SYSTEMS AND METHODS FOR HIGHLY EFFICIENT VIDEO COMPRESSION USING SELECTIVE RETENTION OF RELEVANT VISUAL DETAILS, U.S. patent application Ser. No. 12/176,374, filed Jul. 19, 2008, Attorney Docket No. 54729/P012US/10808779, which applications are hereby incorporated by reference herein.

### TECHNICAL FIELD

This disclosure relates to video signals, digital images, and more specifically to systems and methods for smoothing blocky images by replacing or modifying pixel values of the image.

### BACKGROUND OF THE INVENTION

It is well-known that video signals are represented by large amounts of digital data, relative to the amount of digital data required to represent text information or audio signals. Digital video signals consequently occupy relatively large bandwidths when transmitted at high bit rates and especially when these bit rates must correspond to the real-time digital video signals demanded by video display devices.

In particular, the simultaneous transmission and reception of a large number of distinct video signals, over such communication channels as cable or fiber, is often achieved by frequency-multiplexing or time-multiplexing these video signals in ways that share the available bandwidths in the various communication channels.

Digitized video data are typically embedded with the audio and other data in formatted media files according to internationally agreed formatting standards (e.g., MPEG2, MPEG4, and H264). Such files are typically distributed and multiplexed over the Internet and stored separately in the digital memory of computers, cell phones, digital video recorders (DVRs), compact discs (CDs), and digital video discs (DVDs). Many of these devices are physically and indistinguishably merging into single devices.

In the process of creating formatted media files, the file data is subjected to various levels and types of digital compression in order to reduce the amount of digital data required for their representation, thereby reducing the memory storage requirement, as well as the bandwidth required for their faithful simultaneous transmission when multiplexed with multiple other video files.

The Internet provides an especially complex example of the delivery of video data in which video files are multiplexed in many different ways and over many different channels (i.e., paths) during their downloaded transmission from the centralized server to the end user. However, in virtually all cases, it is desirable that, for a given original digital video source and a given quality of the end user's received, and displayed video, the resultant video file be compressed to the smallest possible size.

Formatted video files might represent a complete digitized movie. Movie files may be downloaded ‘on demand’ for immediate display and viewing in real-time or for storage in end-user recording devices, such as digital video recorders, for later viewing in real-time.

Compression of the video component of these video files therefore not only conserves bandwidth, for the purposes of transmission, but it also reduces the overall memory required to store such movie files.

At the receiver end of the abovementioned communication channels, single-user computing and storage devices are typically employed. Currently-distinct examples of such single-user devices are the personal computer, and the digital set top box, either or both of which are typically output-connected to the end-user's video display device (e.g., TV), and input-connected, either directly or indirectly, to a wired copper distribution cable line (i.e., Cable TV). Typically, this cable simultaneously carries hundreds of real-time multiplexed digital video signals and is often input-connected to an optical fiber cable that carries the terrestrial video signals from a local distributor of video programming. End-user satellite dishes are also used to receive broadcast video signals. Whether the end-user employs video signals that are delivered via terrestrial cable or satellite, end-user digital set top boxes, or their equivalents, are typically used to receive digital video signals and to select the particular video signal that is to be viewed (i.e., the so-called TV channel or TV program). These transmitted digital video signals are often in compressed digital formats and therefore must be uncompressed in real-time after reception by the end-user.

Most methods of video compression reduce the amount of digital video data by retaining only a digital approximation of the original uncompressed video signal. Consequently, there exists a measurable difference between the original video signal prior to compression and the uncompressed video signal. This difference is defined as the video distortion. For a given method of video compression, the level of video distortion almost always becomes larger as the amount of data in the compressed video data is reduced by choosing different parameters for those methods. That is, video distortion tends to increase with increasing levels of compression.

As the level of video compression is increased, the video distortion eventually becomes visible to the human vision system (HVS) and eventually this distortion becomes visibly-objectionable to the typical viewer of the real-time video on the chosen display device. The video distortion is observed as a so-called artifact. An artifact is observed video content that is interpreted by the HVS as not belonging to the original uncompressed video scene.

Methods exist for significantly attenuating visibly-objectionable artifacts from compressed video, either during or after compression. Most of these methods apply only to compression methods that employ the block-based Two-dimensional (2D) Discrete Cosine Transform (DCT) or approximations thereof. In the following, we refer to these methods as DCT-based. In such cases, by far the most visibly-objectionable artifact is the appearance of artifact blocks in the displayed video scene.

Methods exist for attenuating the artifact blocks typically either by searching for the blocks or by requiring a priori knowledge of where they are located in each frame of the video.

The problem of attenuating the appearance of visibly-objectionable artifacts is especially difficult for the widely-occurring case where the video data has been previously compressed and decompressed, perhaps more than once, or where it has been previously re-sized, re-formatted or color re-mixed. For example, video data may have been re-formatted from the NTSC to PAL format or converted from the RGB to the YCrCb format. In such cases, a priori knowledge of the locations of the artifact blocks is almost certainly unknown and therefore methods that depend on this knowledge do not work.

Methods for attenuating the appearance of video artifacts must not add significantly to the overall amount of data required to represent the compressed video data. This constraint is a major design challenge. For example, each of the three colors of each pixel in each frame of the displayed video is typically represented by 8 bits, therefore amounting to 24 bits per colored pixel. For example, if pushed to the limits of compression where visibly-objectionable artifacts are evident, the H264 (DCT-based) video compression standard is capable of achieving compression of video data corresponding at its low end to approximately 1/40th of a bit per pixel. This therefore corresponds to an average compression ratio of better than 40×24=960. Any method for attenuating the video artifacts, at this compression ratio, must therefore add an insignificant number of bits relative to 1/40th of a bit per pixel. Methods are required for attenuating the appearance of block artifacts when the compression ratio is so high that the average number of bits per pixel is typically less than 1/40th of a bit.

For DCT-based and other block-based compression methods, the most serious visibly-objectionable artifacts are in the form of small rectangular blocks that typically vary with time, size, and orientation in ways that depend on the local spatial-temporal characteristics of the video scene. In particular, the nature of the artifact blocks depends upon the local motions of objects in the video scene and on the amount of spatial detail that those objects contain. As the compression ratio is increased for a particular video, MPEG-based DCT-based video encoders allocate progressively fewer bits to the so-called quantized basis functions that represent the intensities of the pixels within each block. The number of bits that are allocated in each block is determined on the basis of extensive psycho-visual knowledge about the HVS. For example, the shapes and edges of video objects and the smooth-temporal trajectories of their motions are psycho-visually important and therefore bits must be allocated to ensure their fidelity, as in all MPEG DCT based methods.

As the level of compression increases, and in its goal to retain the above-mentioned fidelity, the compression method (in the so-called encoder) eventually allocates a constant (or almost constant) intensity to each block and it is this block-artifact that is usually the most visually objectionable. It is estimated that if artifact blocks differ in relative uniform intensity by greater than 3% from that of their immediate neighboring blocks, then the spatial region containing these blocks is visibly-objectionable. In video scenes that have been heavily-compressed using block-based DCT-type methods, large regions of many frames contain such block artifacts.

### BRIEF SUMMARY OF THE INVENTION

The present invention is directed to systems and methods which improve the quality of a digital image or series of images as perceived by the Human Vision System (HVS). Systems and methods herein achieve this improvement by modifying pixel values based on values of statistically similar neighboring pixels. Pixel modification may be dependant or independent of other pixel modifications.

Different embodiments of the invention may be used to improve efficiency of the process. One such embodiment involves modifying only those pixels in the luminance plane, while another also considers the chrominance plane. Other embodiments use appropriate mathematical principles and techniques in addition to the values of statistically similar neighboring pixels to calculate pixel values. Additionally, some embodiments may target specific regions as opposed to pixels.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a typical blocky image which is to be smoothed;

FIG. 2 shows target pixels of a blocky image identified after the image was traversed;

FIG. 3 shows the region that is to be searched for statistically similar pixels;

FIG. 4 shows statistically similar neighboring pixels which have been identified and are to be used to modify the target pixel;

FIG. 5 shows a target pixel modified as a function of the values of the statistically similar neighboring pixels;

FIG. 6 shows one embodiment of a method for smoothing an image or video signal; and

FIG. 7 shows one embodiment of the concepts discussed herein.

### DETAILED DESCRIPTION OF THE INVENTION

This invention applies to sequences of images in video signal processing, and also applies to single digital images alone.

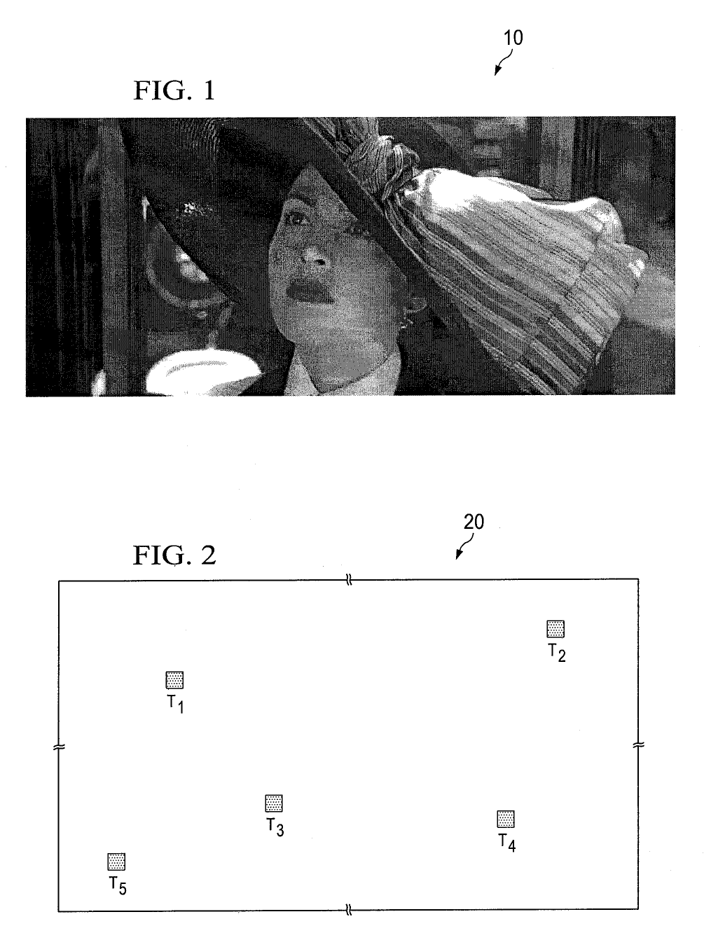

Video scenes consist of video objects. These objects are typically distinguished and recognized (by the HVS and associated neural responses) in terms of the locations and motions of their intensity edges and the texture of their interiors. For example, FIG. 1 shows a typical image frame 10 that contains visibly objectionable block artifacts. While not clearly visible in the image frame of FIG. 1, the block artifacts have various sizes and locations in the image.

A deblocking method is proposed in which each video frame is traversed in a predetermined or adaptive pattern where a selection of pixels is chosen to be compared and adjusted with respect to its neighbors according to certain statistical measures. The method is independent of color space models, resolutions, and frame rates. It has the advantage that it may be applied in a single pass over each frame. FIG. 2 shows an example of a video frame 20, traversed as described by the method above, in which target pixels T₁, T₂, T₃, T₄ and T₅ have been identified.

For the purposes of illustration in the following examples, without implied restriction, assume the video is represented using a YV12 (4:2:0) color space. It has been observed that the majority of block artifacts that appear in highly compressed videos are most noticeable to the Human Visual System (HVS) in the Y (luminance) plane, and only to a lesser extent in the Cr and Cb (chrominance) planes. There is computational relevance in making this distinction since the majority of the visible smoothing may be achieved by way of the Y plane alone.

An aspect of the invention is to determine neighborhoods of related pixels for which smoothing is to be applied for the purpose of removing block artifacts. These neighborhoods are determined on the basis of statistical similarity.

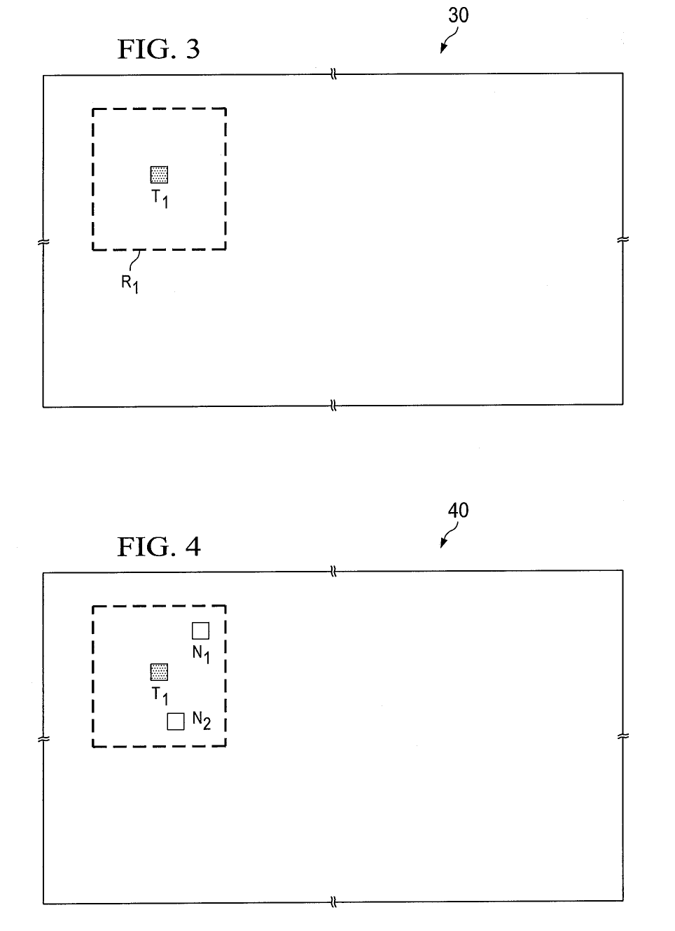

In one embodiment, a selection of target pixels of an image frame is visited from top to bottom and from left to right. For each such target pixel the surrounding region is searched for neighbors statistically similar to the target pixel. Each region is searched in a pattern whose size, shape and sampling density are chosen for reasons of efficiency and statistical significance. FIG. 3 shows a video frame 30 with a surrounding region R₁ of target pixel T₁ to be searched for statistically similar neighbors. The size, shape, and pixel density of R₁ is variable.

A first set of statistical criteria is applied such as absolute or relative intensity difference to determine if a given neighbor is sufficiently similar to be considered as belonging to the same neighborhood as the target pixel. Those beyond a statistically derived threshold do not qualify as related neighbors. The method allows for the determination as to whether or not such a non-qualifying pixel delimits the search region. FIG. 4 shows a representation of a video frame 40, with neighboring pixels N₁ and N₂ which have been found to be statistically similar to target pixel T₁. N₁ and N₂ are within the boundary region R₁.

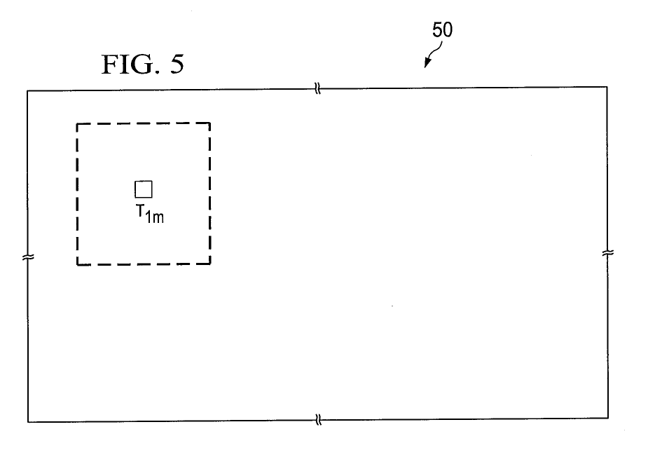

For those qualifying pixels, a second set of statistical measures such as distance weighted average is employed to update the target pixel. This update may be either a direct replacement of the value of the target pixel, or a partial modification to it. FIG. 5 is a representation of a video frame 50, with a modified pixel T₁ₘ. T₁ₘ has been modified based on the values and pixels N₁, and N₂, as shown in FIG. 4.

This traversal process continues until all intended target pixels are visited and possibly modified. In a preferred embodiment, the original neighboring pixel values are used in computing the modified target pixel values, rather than using neighbor pixel values that were modified earlier in the same traversal. This ensures that the resultant values for the target pixels are independent of the pattern of traversal.

The end result for the frame is a significantly smoothed image in which block artifacts are greatly reduced. The degree of smoothing and block artifacts reduction is a function of the selection of target and neighboring pixels, and the statistical measures applied, all of which have both qualitative and performance implications.

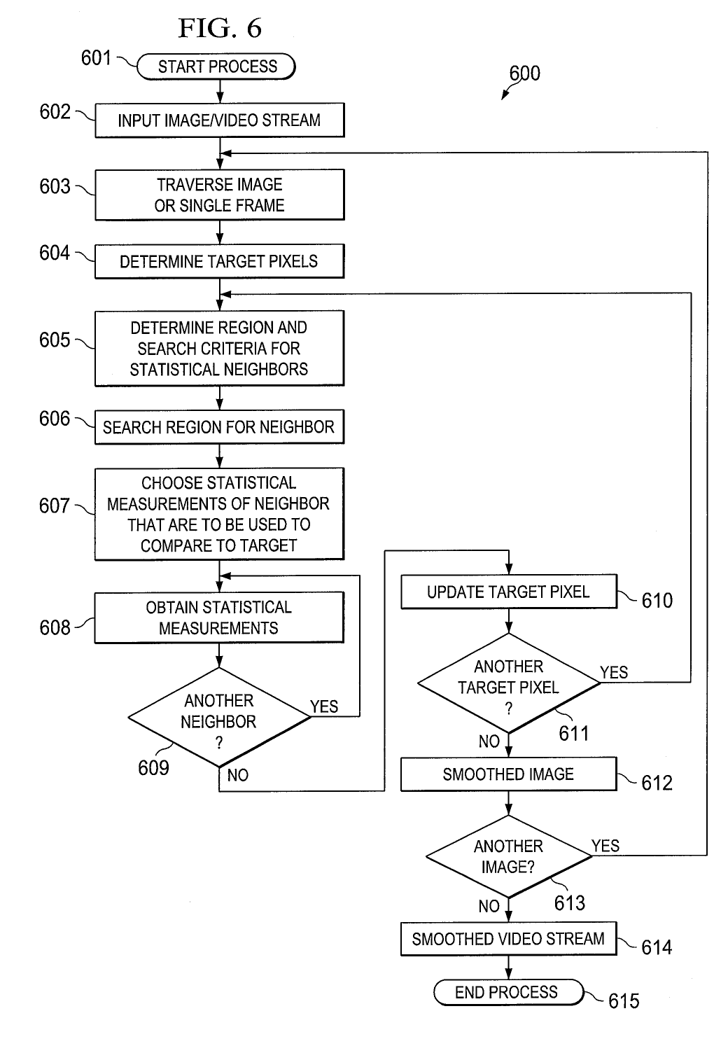

FIG. 6 shows one embodiment, 600, of a method for smoothing an image or video signal. Embodiment 600 can, for example, operate as a program in a processor system. Process 601 begins the process of smoothing an image or video signal. Process 602 inputs a video stream or single image into the smoothing process. Process 603 traverses a single image or frame. Process 604 locates target pixels of the image. Process 605 determines the search region for the target pixel. Process 606 searches the region for statistically similar neighbors. Process 607 selects the statistically similar neighbors in the search region. Process 608 obtains the relevant statistical measurements. Process 609 determines if there are more neighbors from which statistical measurements need to be derived. Process 610 updates the values of the target pixel after measurements have been derived from all neighbors. Process 611 ascertains whether there are more target pixels to update. Process 612 outputs a smoothed image. Process 613 determines whether there are more images to smooth. Process 614 outputs a smoothed video stream based on the smoothed images. Process 615 ends the smoothing process.

In an extended embodiment, the chrominance planes may be used as part of the neighboring region selection criteria, by way of a similar set of statistical measures such as those used to select neighbors based on luminance alone. Secondly, such selected neighbors' chrominance values may also be updated in a similar fashion as the luminance values.

In an alternative embodiment, neighboring pixel values that were modified earlier in a traversal may be used in computing modified target pixel values later in the same traversal. In this case the modified values are not independent of the pattern of traversal.

There are many embodiments that compute the resultant values more efficiently by taking advantage of such principles as locality of access, parallelism and other computational optimization strategies. Such strategies may include, without limitation, row-wise and column-wise summation, selective area partitioning, and local averaging.

Another extended embodiment replaces the concept of a target pixel with a target region of flexible size and shape. This could be achieved via down-sampling, up-sampling, or by various other local area-wise treatments.

Another extended embodiment takes advantage of inter-frame redundancies in order to avoid recalculating the values in those identifiable regions whose differences from previous frames lie below specifiable statistical limits, or for which a suitable transform may be substituted, such as translation, rotation, scaling, or shifting of intensity and/or hue.

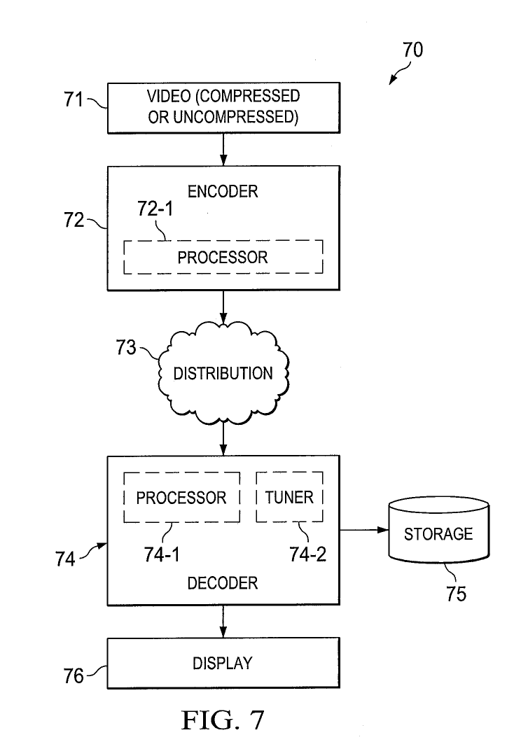

FIG. 7 shows one embodiment 70 of the use of the concepts discussed herein. In system 70 video (and audio) is provided as an input 71. This can come from local storage, not shown, or received from a video data stream(s) from another location. This video can arrive in many forms, such as through a live broadcast stream, or video file and may be pre-compressed prior to being received by encoder 72. Encoder 72, using the processes discussed herein processes the video frames under control of processor 72-1. The output of encoder 72 could be to a file storage device (not shown) or delivered as a video stream, perhaps via network 73, to a decoder, such as decoder 74.

If more than one video stream is delivered to decoder 74 then the various channels of the digital stream can be selected by tuner 74-2 for decoding according to the processes discussed herein. Processor 74-1 controls the decoding and the output decode video stream can be stored in storage 75 or displayed by one or more displays 76 or, if desired, distributed (not shown) to other locations. Note that the various video channels can be sent from a single location, such as from encoder 72, or from different locations, not shown. Transmission from the decoder 74 to the encoder 72 can be performed in any well-known manner using wireline or wireless transmission while conserving bandwidth on the transmission medium.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for deblocking an input image containing visibly objectionable block artifacts, said method comprising:
deriving pixel values from corresponding pixels of said input image in combination with pixel values of statistically similar neighboring pixels within said input image, said derived pixel values comprising a deblocked version of said input image.

2. The method of claim 1 wherein said statistically similar pixels are selected according to statistically similar patterns.

3. The method of claim 1 wherein said neighboring pixels are defined by proximity to each other.

4. The method of claim 3 wherein said proximity is variable.

5. The method of claim 3 wherein said neighboring pixels are further defined by statistical similarity.

6. The method of claim 1 wherein said derived pixel value is representative of a statistically similar sampling of a qualifying neighborhood.

7. A method for deblocking an image, said method comprising:
deriving pixel values of statistically similar neighboring pixels in said image; and replacing pixel values of said image with said derived pixel values.

8. The method of claim 7 wherein said statistically similar neighboring pixels are determined by specified statistical measurement criteria.

9. The method of claim 8 wherein at least one of said measurement criteria is selected from the list of:
absolute intensity, relative intensity, absolute hue, relative hue, proximity to target pixel.

10. The method of claim 7 wherein said replacing is in a replacement image.

11. A method for deblocking a video signal; said method comprising:
traversing a frame of said video signal to select pixels;
comparing each selected pixel to neighboring pixels according to certain statistical measures, said statistical measures pertaining to the luminance and chrominance planes of said video signal; and
replacing pixel values of said traversed frame with pixels values derived by said comparing, said replacing occurring in a substitute frame of said video signal.

12. The method of claim 11 wherein said traversing comprises at least one of the following:
an adaptive pattern using; and
a predetermined pattern using.

13. The method of claim 11 wherein said replacing is sequential with respect to pixels in said frame.

14. The method of claim 11 wherein all of said pixels of a frame are replaced substantially concurrently.

15. The method of claim 11 wherein said statistical measures comprise the use of statistically similar pixels determined using relative intensity differences.

16. The method of claim 11 further comprising:
concurrently traversing multiple images of video sequence.

17. The method of claim 11 wherein pixel values are replaced in an image of a video signal independent of each other.

18. The method of claim 11, wherein pixel values are replaced in an image of a video signal dependent upon other pixel replacement values.

19. The method of claim 11 wherein pixel values from multiple transversals are used to determine a replacement pixel value.

20. The method of claim 11 wherein pixel values are computed using principals including, but not limited to, parallelism and locality of access.

21. The method of claim 11 wherein a previously traversed image may be used in its entirety as the substituted frame with suitable transform such as translations, rotations, scaling or shifting of intensity and/or hue.
